(19) United States
(12) Patent Application Publication
(10) Pub. No.: US 2011/0101623 A1
(43) Pub. Date: May 5, 2011

(54) FLAT SEAL

(76) Inventors: Rolf Prehn, Wipperfürth (DE); Rainer Capellmann, Burscheid (DE)

(21) Appl. No.: 13/000,433

(22) PCT Filed: Jun. 19, 2009
(86) PCT No.: PCT/DE09/00841

§ 371 Date: Dec. 21, 2010

(30) Foreign Application Priority Data
Jun. 21, 2008 (DE) 10 2008 029 545.0

(51) Int. Cl. F02F 11/00

(52) U.S. Cl. 277/591

(57) ABSTRACT

A flat seal, in particular a cylinder head gasket or an exhaust flange seal, includes at least one layer provided with at least one through opening. The through opening receives at least one elastically deformable profiled body configured as an annular profile wire. The profiled body, when seen in the radial direction, has different material thicknesses and is functionally connected to at least one support body.

The invention relates to a flat gasket, in particular to a cylinder head gasket or an exhaust flange gasket.

It is known for the cylinder head gaskets, which consist of several layers, how to connect the different layers to each other by using appropriate joining technologies (e.g. clinching, welding). With the help of the so-called stopper members, which are built with additionally inserted rings, layers or stampings, the necessary height difference at the combustion chamber edge is adjusted to the remaining surface area of the flat gasket.

A gasket configuration for a combustion engine is known from EP 0 538 628 A2, which contains a cylinder head, a motor block and a cylinder liner inserted in a drilled hole of the motor block and supported by it, a hollow cylindrical part, a sealing collar in the form of a ring stretching radially outwards from the cylindrical part, a piston bore and a collar joint surface essentially pointing to the cylinder head and containing further sealants which are engaged with the collar joint surface and a corresponding cylinder head sealing surface in order to prevent the escape of combustion gases from the piston bore. At least one of the two sealing surfaces is built in a frustroconical form and is extending continuously from a radially internal circumferential area to a radially external circumferential area, whereby the radially internal circumferential area is spaced apart farther from the other sealing surface than the radially external area.

The task of the invention is to propose a new sealing concept for flat gaskets using alternative sealing elements which can function both as a sealing element and as a compression delimiter or a stopper element.

Another objective is to permit the targeted adjustment of the force distribution in a sealing system which, as a rule, is determined by bolt forces.

The task is solved by means of a flat gasket, in particular a cylinder head gasket or an exhaust flange gasket, containing at least one layer provided with at least one through opening, whereby the through opening receives at least one elastically malleable profile element built as a profile wire with a ring form which, seen in radial direction, has different material thickness and is in operative connection with at least one support element.

Other advantageous implementations of the object of the invention are provided in the sub claims.

The support elements can be built as at least one distance washer.

Alternatively, there is a possibility to design the support element as a bezel which either consist of two spaced distance washers or has essentially a U-form cross section and encloses the profile element,

The free end or the free ends of the respective support element, which are provided at the layer side, can be connected in the area of their ends at the layer side with the corresponding layer. Traditional force-fit, forming or material-consistent connection technologies such as clinching, welding or riveting can be used to this purpose.

According to another idea of the invention, when a distance washer is used as a support element, it can be positioned in such a way with respect to the layer, so that the support element and the layer could lie in a horizontal plane. In this case there is a possibility to position the layer and the support element on a common carrier element, whereby, if necessary, the layer and/or the support element can be connected with the carrier element, for example, by means of butt welding.

According to another idea of the invention, the layer can be provided on the side of the profile element with a spaced, for example, stamped section which receives at least partially an aim of a support element in use, whereby the thickness of the material of the support element is greater than the depth of at least one spaced section.

Alternatively, it is also possible to build the free arm end of at least one support element with respect to the material thickness in such a way, so that it runs in the plane of the layer. If necessary, at least one half-bead can be formed on the support element on the side of the profile element.

The alternatively proposed design measures ensure that an optimal force distribution can be set up within the sealing system. As this can be seen from the design implementation forms, this, as a rule, is achieved by the height differences between the combustion chamber sealing and the media sealing. If the media sealing and the combustion chamber sealing have the same height (additional precondition: the used gaskets have the same strength and rigidity), then it can be proceeded from a uniform load distribution. If the heights of the media sealing and the combustion chamber sealing are different, then higher load will be applied to the sealing element. Based on the manufacturing tolerances, the case that the two sealing elements have the same height is a statistical coincidence. In order that the combustion chamber sealing could receive a larger portion, e.g. 60%, of the bolt forces, so that the sealing function could be always ensured, it is worked, as a rule, with the so-called supernatant of the combustion chamber sealing. This means that the combustion chamber sealing must be built at a higher level than the media sealing. The alternative implementation forms of the object of the invention are offered to this purpose.

The object of the invention is presented in the figure and will be described in more details further below. The figure shows the following items:

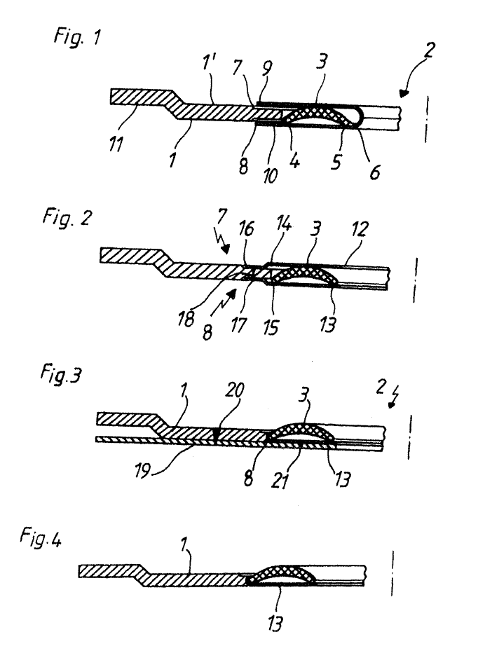

FIG. 1 Profile element with a bezel;

FIG. 2 Profile element with a welded bezel;

FIG. 3 Profile element with a distance washer;

FIG. 4 Profile element with a connected distance washer;

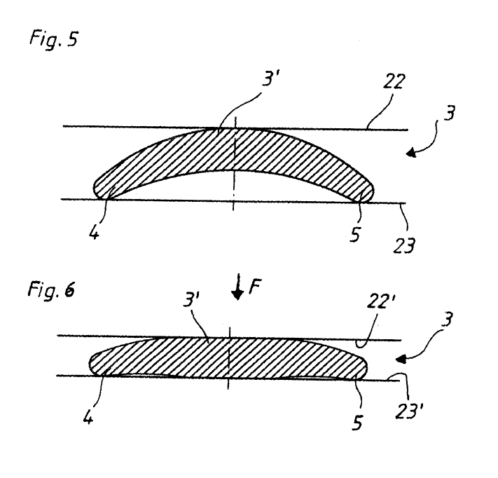

FIGS. 5 and 6 Profile element with according to FIGS. 1 to 4, on the one hand, in a preassembled state and, on the other hand—in a state of total compression.

FIG. 1 shows only a marked layer 1 of one not completely shown cylinder head gasket with at least one through opening 2. Alternatively, the layer 1 can be also part of an exhaust flange gasket. A profile element 3 built as profile wire and with a geometric form similar to a banana is positioned in the through opening 2. The largest material cross section (core area) is located in the middle section of the profile wire 3, while the end sections 4, 5 form the so-called bending area and have a rounded shape. The profile wire 3 is surrounded by a bezel 6 with a U-form cross section. The layer 1, which is implemented here as a metal layer, has in the area of the through opening 2 spaced sections 7, 8 formed by stamping, whereby the free leg ends 9, 10 end the bezel 6 in these spaced sections 7, 8.

It is only indicated that the layer 1 is provided with a bead, in particular with a half-bead 11. As it has already been mentioned, the object of the invention must ensure a defined distribution of force in tightening the bolts. To this purpose, the material thickness of the bezel 6 of the leg ends 9, 10 is greater than the depth of the spaced sections 7, 8, so that there is a certain protrusion to the surface 1′ of the layer 1. The height difference between the combustion chamber sealing and the media sealing is adjusted through the thickness of the free ends 9, 10 of the bezel 6 in connection with the spaced sections 7, 8 of the layer 1. If necessary, the free ends 9, 10 of the bezel 6 can be connected with the layer 1 by using an appropriate joining process. However, the latter is not necessary for the function.

FIG. 2 shows the profile element 3 according to FIG. 1. Unlike FIG. 1, no closed bezel is provided here and instead two distance washers 12, 13 are provided, with the profile element 3 positioned between them. Each distance washer 12, 13 is provided with a beaded section 14, 15, whereby the corresponding free end 16, 17 of each distance washer 12, 13 is connected with the spaced section 7, 8 of the layer 1, for example through a weld seam 18.

Further on, the connection type according to FIGS. 1 and 2 offers a possibility that the profile element 3 does not have to be inserted perforce into a ring. This means that in this case it is possible to use a ring in which—similarly to a piston ring—the two ends meet with each other in a stump manner without being firmly connected to each other.

FIG. 3 shows the layer 1 along with the through opening 2 and the profile element 3 placed there. Only one lower distance washer 13 is provided here, whereby the thickness of the material of distance washer 13 and the depth of the spaced section 8 are identical, so that the layer 1 and the distance washer 13 are positioned in the same horizontal plane. In addition, both the parts of the layer 1 and the distance washer 13 lie on a common support element 19 (protection layer). In this example, the protection layer 19 is connected with the layer 1 by using an appropriate joining process (spot weld 20). In the same way, the distance washer 13 is connected with the protection layer 19 by means of a spot weld 21.

FIG. 4 is similar to FIG. 3, except that there is no protection layer and only the distance washer 13 is provided in the horizontal plane of layer 1.

The profile wire 3, which is built as a profile element, can be either partially or completely connected with the layer 1 or positioned radially mobile in the through opening 2. The layer 1 itself can—but is not necessarily—be built of metal. The implementation forms presented in FIGS. 1 to 4 have the advantage that the profile element 3 is not in direct contact with the motor block or the cylinder head or other flange surfaces and as a result the above-mentioned embeddings of the profile element 3 in the surface of the corresponding flange, the respective motor block or cylinder head are avoided.

FIGS. 5 and 6 show the profile element 3 presented in FIGS. 1 to 4 as a detail, on the one hand, in a preassembly condition (FIG. 5) and on the other hand—in a state of total compression (FIG. 6).

A so-called core element 3′ is built between the springy ends 4, 5 forming bending sections. In FIG. 5, a cylinder head 22 and a motor block 23 are only marked. When force F is applied, e.g. by tightening bolts, the respective bending section 4, 5 is deformed in radial direction, while in the case of total compression (FIG. 6) the core element 3′ is clamped between the sealing surfaces 22′. 23′ and thus a stop area is formed. As a result, a kind of three-point support 4, 5, 3′ is built, whereby the bending sections 4, 5 remain elastically deformable and thus are also capable to follow the dynamic fluctuations of the gasket.

Not shown, but enclosed in a protection scope, is the possibility to build the respective support elements 6, 12, 13, seen in the scope direction, with different thickness or as stiff elements. With these measures, targeted topographies can be set up. In this way, for example, the smaller thickness of the support elements 6, 12, 13 in the bolts area can lead to uniformity of the load seen above the scope of the through opening 2.

1. A flat gasket comprises, at least one layer provided with at least one through opening, whereby the through opening receives at least one elastically malleable profile element built as a profile wire with a ring form which, seen in radial direction, has different material thickness and is in operative connection with at least one support element.

2. A flat gasket according to claim 1 wherein the support element is connected with the layer.

3. A flat gasket according to claim 1 wherein the support element is built as comprises a distance washer.

4. A flat gasket according to claim 1 wherein the profile element has two front faces and is surrounded at least partially in the area of its two front faces by at least one support element.

5. A flat gasket according to claim wherein the support element comprises a bezel which surrounds the profile element.

6. A flat gasket according to claim 1 wherein the layer is provided on the side of the through opening with at least one spaced section, which reduces the thickness of the layer, and an outside radial leg end of the support element ends in this area.

7. A flat gasket according to claim 1 wherein the support element forms a common bearing surface with the layer.

8. A flat gasket according to claim 1 wherein the support element and the layer lie on a common carrier element and, if necessary, are connected to it.

9. A flat gasket according to claim 1 wherein the thickness of the material of the support elements is greater than the thickness of at least on spaced section of the layer.

10. A flat gasket according to claim 1 wherein the support element is provided on the side of the profile element with a half-bead.

11. A flat gasket according to claim 1 wherein the profile element is connected with the layer.

12. A flat gasket according to claim 1 wherein the profile element can move radially within the through opening of the layer.

13. A flat gasket according to claim 1 wherein the profile element is built as an open or closed ring.

14. The flat gasket of claim 1 comprising a cylinder head gasket or an exhaust flange gasket.

15. The flat gasket of claim 8 wherein the support element and layer are connected to the common carrier element.
